(19) United States
(12) Patent Application Publication
(10) Pub. No.: US 2012/0230293 A1
(43) Pub. Date: Sep. 13, 2012

(54) METHOD OF PERFORMING AN INTER-TECHNOLOGY HANDOFF IN A LOOSELY COUPLED ARCHITECTURE

(76) Inventors: EDWARD GRINSHPUN, Freehold, NJ (US); David Faucher, Guthrie Center, IA (US); Peter Andrews, Middletown, NJ (US)

(21) Appl. No.: 13/042,777

(22) Filed: Mar. 8, 2011

(51) Int. Cl. H04W 36/14; H04W 92/02

(52) U.S. Cl. 370/331

(57) ABSTRACT

The present invention provides embodiments of methods for performing inter-technology handoffs in a loosely coupled network architecture. One embodiment of the method includes configuring a downlink data path from a target access network to a mobile device concurrently with transmitting a data path registration request from the target access network to an anchor point during handoff of the mobile device from a source access network to the target access network.

### BACKGROUND OF THE INVENTION

1. Field of the Invention

This invention relates generally to communication systems, and, more particularly, to wireless communication systems.

2. Description of the Related Art

A conventional communication system uses one or more access nodes to provide network connectivity to one or more mobile nodes units or access terminals. The access nodes may be referred to as access points, access networks, base stations, base station routers, cells, femtocells, pico-cells, and the like. For example, in a cellular communication system that operates according to Long Term Evolution (LTE) standards and/or High Rate Packet Data (HRPD, eHRPD) standards defined by the Third Generation Partnership Project (3GPP, 3GPP2), one or more nodes may be used to provide wireless network connectivity to mobile units The mobile units may include cellular telephones, personal data assistants, smart phones, Global Positioning Systems, navigation systems, network interface cards, notebook computers, desktop computers, other user equipment such as may be defined in 3GPP standards documentation, mobile stations such as defined in WiMAX standards documentation, and the like. Numerous types and generations of wireless communication systems have been developed and deployed to provide network connectivity to mobile nodes. Exemplary wireless communication systems include systems that provide wireless connectivity to micro cells (e.g., systems that provide wireless connectivity according to the IEEE 802.11, IEEE 802.15, or Wi-Fi standards) and systems that provide wireless connectivity to macro cells (e.g., systems that operate according to the 3GPP, 3GPP2 standards and/or systems operate according to the IEEE 802.16, WiMAX, and IEEE 802.20 standards). Multiple generations of these systems have been deployed including Second Generation (2G), Third Generation (3G), and Forth Generation (4G) systems.

The coverage provided by different service providers in a heterogeneous communication system may intersect and/or overlap. For example, a wireless access node for a wireless local area network may provide network connectivity to mobile nodes in a micro cell or pico-cell associated with a coffee shop that is within the macro cell coverage area associated with a base station of a cellular communication system. For another example, cellular telephone coverage from multiple service providers may overlap and mobile nodes may therefore be able to access the wireless communication system using different generations of radio access technologies, e.g., when one service provider implements a 3G system and another service provider implements a 4G system. For yet another example, a single service provider may provide coverage using overlaying radio access technologies, e.g., when the service provider has deployed a 3G system and is in the process of incrementally upgrading to a 4G system.

Mobile units that roam throughout the wireless communication system can be handed off between access nodes that operate according to different radio access technologies. For example, a multi-mode mobile unit may roam from a macrocell that operates according to the Long Term Evolution (LTE) or WiMAX radio access network (RAN) standards to a microcell or hotspot that is served by a WiFi access point. Mobile units users do not like service interruptions and may be frustrated or annoyed if they perceive any degradation of the service caused by handing over between different serving nodes. Service providers therefore set the provision of seamless roaming across different wireless technologies as a critically important priority when designing and deploying heterogeneous networks.

### SUMMARY OF CLAIMED EMBODIMENTS

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for performing inter-technology handoffs in a loosely coupled network architecture. One embodiment of the method includes configuring a downlink data path from a target access network to a mobile device concurrently with transmitting a data path registration request from the target access network to an anchor point during handoff of the mobile device from a source access network to the target access network. Another embodiment includes receiving a downlink packet from a target access network before receiving a data path registration response indicating that an anchor point has switched a data path binding from a source access network to the target access network in response to a request to handoff the mobile device from the source access network to the target access network.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates a first exemplary embodiment of a wireless communication system;

FIG. 2 conceptually illustrates a second exemplary embodiment of a wireless communication system;

FIG. 3 conceptually illustrates a third exemplary embodiment of a wireless communication system;

FIG. 4 conceptually illustrates a first exemplary embodiment of a method of performing handoff of a mobile unit between radio access networks that operate according to different radio access technologies; and

FIG. 5 conceptually illustrates a second exemplary embodiment of a method of performing handoff of a mobile unit between radio access networks that operate according to different radio access technologies.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Generally, the present application describes techniques for performing handoffs between radio access networks in a loosely coupled wireless communications network architecture. For example, embodiments of the techniques described herein can be used to support inter-technology handoffs between radio access networks (RANs) that operate according to different radio access technologies. The radio access networks in loosely-coupled interworking architectures are disjoint and so control plane or data plane interfaces may not be provided between radio access networks in the loosely-coupled system. For example, loosely-coupled heterogeneous networks do not support data tunneling inter-RAN interfaces between 3G-4G or WiFi RANs during inter-technology handover. Loosely-coupled interworking architectures are much simpler to implement because they do not require interworking related changes in the legacy RAN equipment. Session continuity is maintained via a common Internet Protocol (IP) Mobility anchor point in the packet core that is a common anchor point for the radio access networks that operate according to the radio access technologies supported by the heterogeneous network. In various embodiments, the common Internet Protocol (IP) Mobility anchor point can be implemented in entities such as a 3GPP eUTRAN Packet Data Network (PDN) Gateway (for 2G-3G-4G-WiFi interworking with LTE), a Mobile IP Home Agent (HA) or Local Mobility Anchor (LMA) used for interworking of technologies utilizing Mobile IP, and the like.

The absence of control plane or data plane interfaces between the radio access networks may lead to delays and/or disruptions during inter-technology handoffs of mobile devices. For example, a mobile unit may initiate a handover sequence by transmitting a registration message via the target radio access network to the common anchor point. The anchor point switches the data path binding from the source radio access network to the target radio access network and begins forwarding data towards the target radio access network concurrently with sending a registration response, which triggers the target radio access network to configure the data path between the anchor point to the mobile device. Transmission and/or processing delays while configuring the downlink data path from the target access network to the mobile device may cause streaming packets to be lost. For example, downlink video packets that are streamed from the anchor point to the mobile device according to the real-time transport protocol over user datagram protocol (RTP-over-UDP) may be lost because of a time gap between when the anchor point switches the binding and when the target access network configures the downlink data path to the mobile device. Embodiments of the target access network described herein may therefore configure a downlink data path from the target access network to a mobile device concurrently with transmitting a data path registration request from the target access network to an anchor point during handoff of the mobile device from the source access network to the target access network.

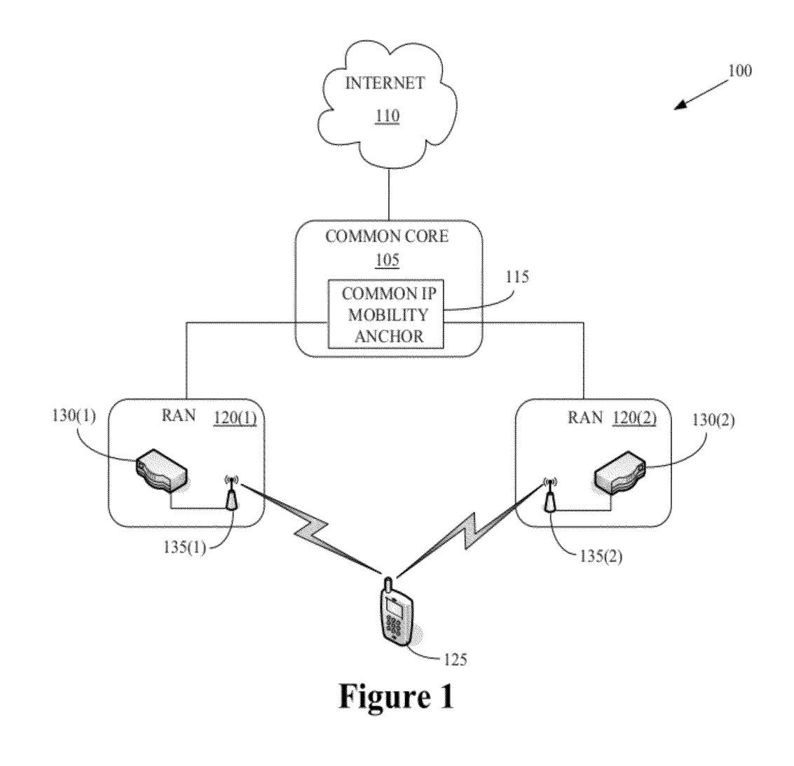

FIG. 1 conceptually illustrates a first exemplary embodiment of a wireless communication system 100. In the illustrated embodiment, a common core network 105 is electronically and/or communicatively coupled to a broader network such as the Internet 110. The common core 105 includes a common IP mobility anchor 115 that serves as an anchor point for one or more radio access networks 120. In the illustrated embodiment, the common IP mobility anchor 115 performs network layer (L-3) functions such as network routing, fragmentation and reassembly of packets, and reporting delivery errors. For example, the common core 105 may function as a Mobile IP home agent (MIP-HA), a packet data node gateway (PDN-GW), or other mobility anchor. In the illustrated embodiment, depending upon the access technology defined standards, the common IP mobility anchor 115 terminates data path tunnels between the anchor 115 and one or more access networks (nodes) or wireless communication devices such as the mobile unit 125. Packets that are forwarded along the data paths tunnels can be addressed in the uplink direction using IP addresses for the network peers of the mobile unit and in the downlink direction using IP addresses of the mobile unit 125. The data paths can pass through either of the radio access networks 120 shown in FIG. 1.

Each radio access network 120 includes one or more access routers 130 that are coupled to one or more access nodes 135. The access routers 130 implement link layer and/or medium access control layer (L-2) functionality and can support an L-2 data path over the air interface between the access nodes 135 and the mobile units 125. For example, the access routers 130 may function as a mobile IP foreign agent, a proxy mobile IP client, a General Packet Radio Service (GPRS) tunneling protocol client, and the like. Exemplary access nodes 135 include base stations, base station routers incorporating access router functions, femtocells, WiFi access points, and the like. In the illustrated embodiment, the radio access networks 120 operate according to different wireless access technologies. For example, the radio access network 120(1) may operate according to 4G standards (e.g., the 3GPP eUTRAN LTE, and/or WiMAX standards) and/or protocols and the radio access network 120(2) may operate according to WiFi or 3G standards and/or protocols (e.g., the 3GPP2 HRPD/eHRPD and/or 3GPP WCDMA-UMTS standards). However, persons of ordinary skill in the art should appreciate that other combinations of wireless access technologies may also be used.

The radio access networks 120 are loosely coupled. As used herein, the term “loosely coupled” will be understood to mean that control plane or data plane interfaces have not been provided between the radio access networks 120 in the system 100. Control plane and data plane signaling associated with one radio access network 120(1) may not be conveyed to the other radio access network 120(2) without passing through the common core 105. Consequently, data paths for the mobile unit 125 are anchored at the common IP mobility anchor 115, which is also responsible for switching the data path between the radio access networks 120 during handoffs of the mobile unit 125. Session continuity is maintained in the loosely-coupled interworking architecture by making the IP Mobility anchor point 115 common for all radio access technologies. As shown in FIG. 1, the anchor point may be implemented in the packet core 105. In exemplary embodiments, the anchor point 115 may implement a MIP home agent/LMA or 3GPP-defined packet data network gateway (PDN GW) function with IP level tunneling towards a local access router 130 in the serving RAN 120. In one embodiment, the local access router 130 may implement a 3GPP S-GW function with a (possibly separate) control plane mobility management entity (MME) function, an MIPv4 foreign agent (FA) or MIPv6 access router function, a PMIP client function, and the like. The access router 130 also supports L2 level tunneling to the mobile device 125 over the specific RAN 120.

Loose coupling can be contrasted with tight coupling, which is characterized by the presence of control plane and/or data plane interfaces between the radio access networks 120. Loosely coupled networks are oriented towards dual-radio or multi-mode mobile units that include two or more independent radio transceivers so that the multi-mode mobile unit can maintain separate physical layer and data layer connections to the radio access networks 120. In contrast, tightly coupled networks are oriented towards single radio mobile units that maintain physical layer and data layer connections to the tightly coupled network using a single interface. Some combinations of standards and/or protocols require loose coupling when they are implemented in the same heterogeneous network. For example, typical WiFi networks cannot be tightly coupled to 3G/4G networks because the WiFi air interfaces do not support the link layer and/or medium access control layer messaging required for 3G/4G. The loosely-coupled interworking architecture may be simpler to implement than a tightly coupled system, at least in part because the loosely coupled system may not require interworking-related changes in legacy RAN equipment.

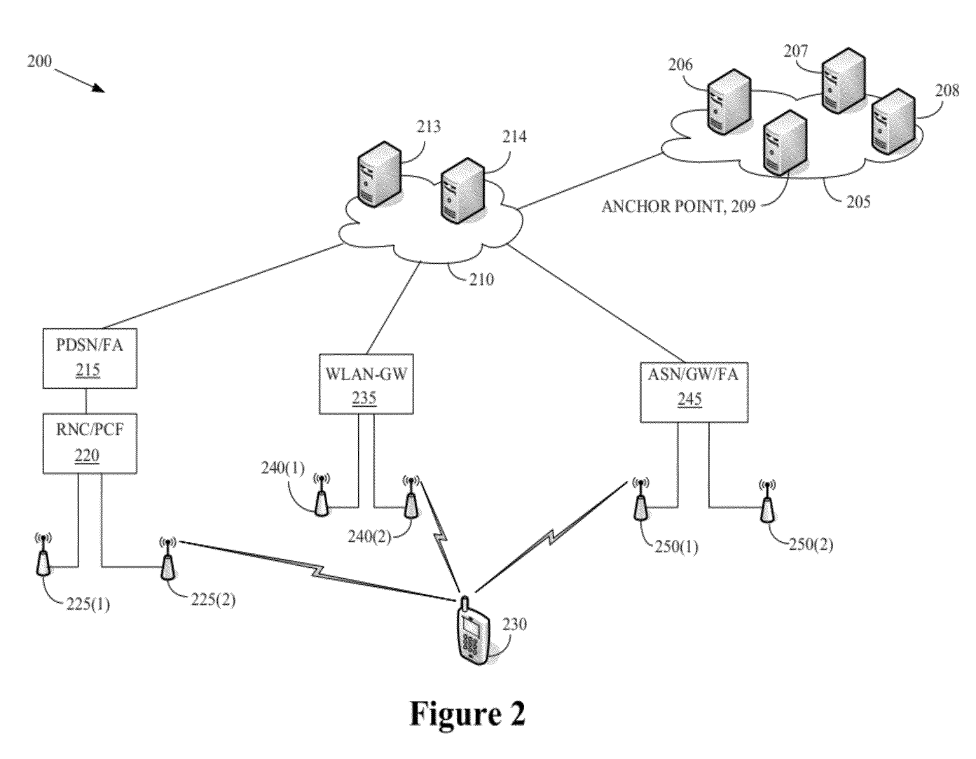

FIG. 2 conceptually illustrates a second exemplary embodiment of a wireless communication system 200. In the illustrated embodiment, the wireless communication system 200 includes a home core serving network 205 that includes a Policy and Charging Rules Function (PCRF) server 206, a billing server 207, a home authentication authorization, and accounting (AAA) server 208, and a home agent 209 that may serve as the common IP mobility anchor point for devices within the system 200. The wireless communication system 200 also may include a visited core network 210 that may include a visited AAA server 213 and a visited PCRF 214. Techniques for implementing and operating the elements of the networks 205, 210 are known in the art and in the interest of clarity only those aspects of implementing and/or operating the elements of the networks 205, 210 that are relevant to the claimed subject matter will be discussed herein. Furthermore, persons of ordinary skill in the art having benefit of the present disclosure should appreciate that the wireless communication system 200 may include other elements that are not shown in FIG. 2 in the interest of clarity.

The wireless communication system 200 uses a loosely coupled interworking architecture to support interworking between access technologies including 3GPP2 High Rate Packet Data (HRPD) technologies, WiMAX technologies, and WiFi technologies. In the illustrated embodiment, the HRPD network includes one or more packet data serving nodes (PDSN) 215, which may also serve as a foreign agent for a roaming device that is anchored at the home agent 209. The PDSN 215 is electronically and/or communicatively coupled to one or more radio network controllers (RNCs) 220 that may also implement a point coordination function (PCF). The RNC 220 controls and coordinates communication between one or more base stations 225 and various wireless communication devices such as the mobile unit 230. The WiFi network includes wireless local area network gateways (WLAN-GW) 235 that oversee wireless communication between access points 240 and wireless communication devices such as the mobile unit 230 that operate according to IEEE 802.11 protocols. The WiMAX system includes access serving networks (ASN) 245 that control access to the network 210 for devices that are in communication with access nodes 250. The ASN 245 may also function as a WiMAX gateway and/or foreign agent. Standards and protocols for implementing and operating HRPD, WiMAX, and WiFi networks are known in the art and in the interest of clarity only those aspects to implementing and operating these networks that are relevant to the claimed subject matter will be discussed herein.

The HRPD, WiMAX, and WiFi networks in the heterogeneous network 200 are loosely coupled and so the home agent 209 may serve as the mobility anchor point for wireless devices such as the mobile unit 230. Data path tunnels between home agent 209 and HRPD and WiMAX radio access networks may be based upon Mobile IP (CMIP or PMIP). In the illustrated embodiment, there are no control plane or data plane interfaces between the HRPD network (e.g., the PDSN 215, the RNC 220, and the base stations 225), the Wifi network (e.g., the WLAN 235 and the access points 240), and the WiMAX network (e.g., the ASN 245 and the access nodes 250). At least in part to reduce delays, latency, and jitter during handover of downlink streaming sessions between the different technologies, routers in the HRPD, WiMAX, and WiFi networks may be able to configure a downlink data path from the target access nodes 225, 240, 250 to the wireless device 230 concurrently with transmitting a data path registration request to the home agent 209 (or other mobility anchor point in the home core serving network, CSN 205) during handoff of the device 230 between the different technologies in the network 200. For example, the PDSN 215, WLAN-GW 235, and ASN 245 may function as access routers and may be able to perform the downlink pre-configuration of the associated access nodes 225, 240, 250. In one embodiment, handovers of the mobile device 230 may be performed according to the flavors of Mobile IP (CMIP or PMIP) protocols defined by the different wireless access technology standards.

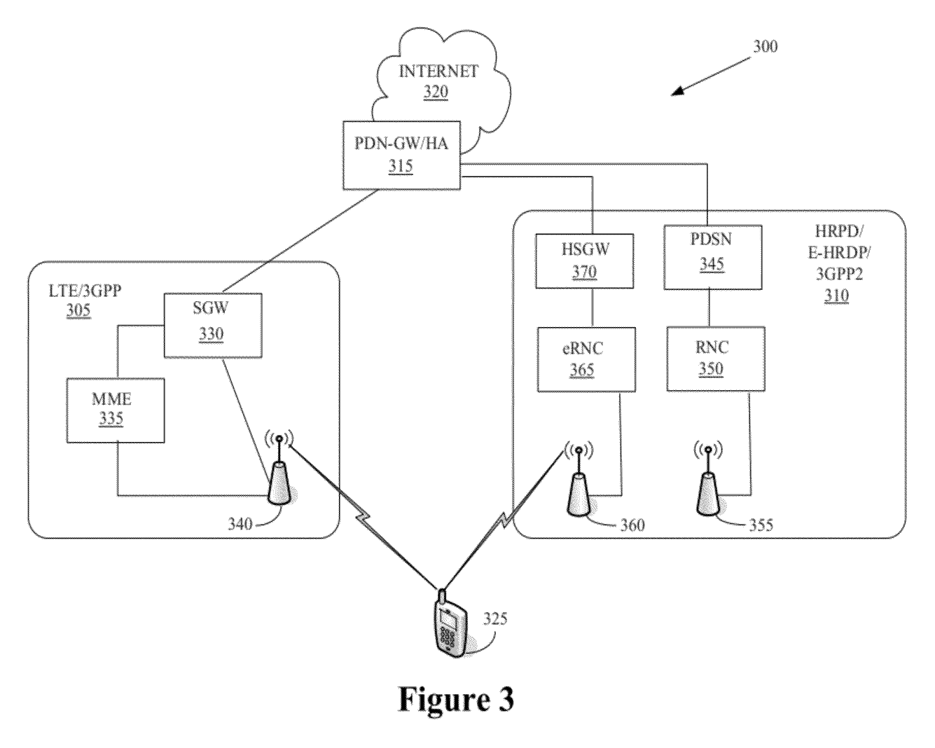

FIG. 3 conceptually illustrates a third exemplary embodiment of a wireless communication system 300. In the illustrated embodiment, the wireless communication system 300 is constructed as a loosely coupled architecture for interworking an LTE access network 305 as defined by 3GPP and a High Rate Packet Data (HRPD)/Evolved HRPD (eHRPD) access network 310 as defined by 3GPP2. Data plane and control plane signaling may not be supported between the access networks 305, 310 and so the wireless communication system 300 implements a loosely coupled architecture to support interworking between the different radio access technologies supported by the access networks 305, 310. The common IP mobility anchor point may be implemented in a PDN-GW 315 to an Internet protocol network 320. The anchor point 315 can terminate network level data flows between the Internet 320 and a dual-mode or multimode mobile unit 325 that can communicate according to the different technologies implemented by the access networks 305, 310. The PDN-GW 315 may also serve as an LMA that implements a home agent function for the mobile unit 325. The mobile unit 325 may therefore roam and be handed off between the access networks 305, 310.

In the illustrated embodiment, the access network 305 includes a serving gateway (SGW) 330, a mobility management entity (MME) 335, and one or more base stations or eNodeBs 340. In embodiments defined according to the LTE standards and/or protocols, the MME 335 is a control-node for the LTE access-network 305 and may be responsible for idle mode UE tracking and paging procedure including retransmissions. The MME 335 may support bearer activation/deactivation processes and be also responsible for choosing the SGW 330 for a UE at the initial attach and at time of intra-LTE handover involving Core Network (CN) node relocation. The MME 335 may also be responsible for authenticating the user and terminating Non-Access Stratum (NAS) signaling. The MME 335 is the termination point in the network for ciphering/integrity protection for NAS signaling and handles the security key management. In embodiments defined according to the LTE standards and/or protocols, the SGW 330 routes and forwards user data packets. The SGW 335 may also manage and store UE contexts, e.g. parameters of the IP bearer service, and network internal routing information. The base station 340 may be an eNodeB and implements the physical layer functionality that supports the air interfaces with user equipment such as the mobile unit 325.

In the illustrated embodiment, the access network 310 includes a HRPD access network with PDSN 345, a radio network controller (RNC) 350, and a base station 355. The illustrated embodiment also includes an eHRPD access network with evolved BTS (eBTS) 360, an evolved RNC (eRNC) function 365, and an HRPD Serving Gateway (HSGW) 370. In embodiments that operate according to the 3GPP2 standards and/or protocols, the PDSN 345 may act as the connection point between the radio access network 310 and IP networks 320. The PDSN 345 may also be responsible for managing point-to-point protocol (PPP) sessions between the mobile provider's core IP network and the mobile unit 325. The PDSN 345 may therefore also support mobility management functions and/or packet routing functionality. In embodiments that operate according to the 3GPP2 standards and/or protocols, the radio network controller 350 is responsible for controlling the base stations 355 within the access network 310. The radio network controller 350 is responsible for performing radio resource management, handling mobility management functions, and encrypting data before the user data is sent to the mobile unit 355.

The access networks 305, 310 in the heterogeneous network 300 are loosely coupled and so the PDN-GW 315 may serve as the mobility anchor point for wireless devices such as the mobile unit 325. Data path tunneling between PDN-GW 315 and the S-GW 330 may be based upon GTP (GPRS tunneling protocol) tunnels or PMIP tunnels. Data path tunneling between PDN-GW 315 and the HRPD PDSN 345 may be based upon PMIP or CMIP. In the illustrated embodiment, control plane or data plane interfaces are not available for communication between the LTE access network 305 (e.g., the SGW 330, the MME 335, and the eNodeB 340), the HRPD access network 310 (e.g., the PDSN 345, the RNC 350, and the nodeB 355), and the eHRPD access network (HSGW 370, the eRNC 365, and the eBTS 360). At least in part to reduce delays, latency, and jitter during handover of downlink streaming sessions between the different technologies, routers in the LTE network 305 and the HRPD/eHRPD networks 310 may be able to configure a downlink data path from the target access nodes 340, 355, 360 to the mobile unit 325 concurrently with transmitting a data path registration request to the PDN gateway 315 (or other mobility anchor point) during handoff of the device 325 between the different technologies in the network 300. For example, the SGW 330 may function as an access router that operates according to GTP, the PDSN 345 may function as an access router (and foreign agent) that operates according to MIPv4, and the HSGW 370 may function as access router and operate according to PMIP6. These elements of the access networks 305, 310 may be able to perform downlink pre-configuration of the associated access nodes 340, 355, 360. In one embodiment, handovers of the mobile device 325 may be performed according to the corresponding wireless standard specific flavors of Mobile IP (CMIP or PMIP) or GTP protocols.

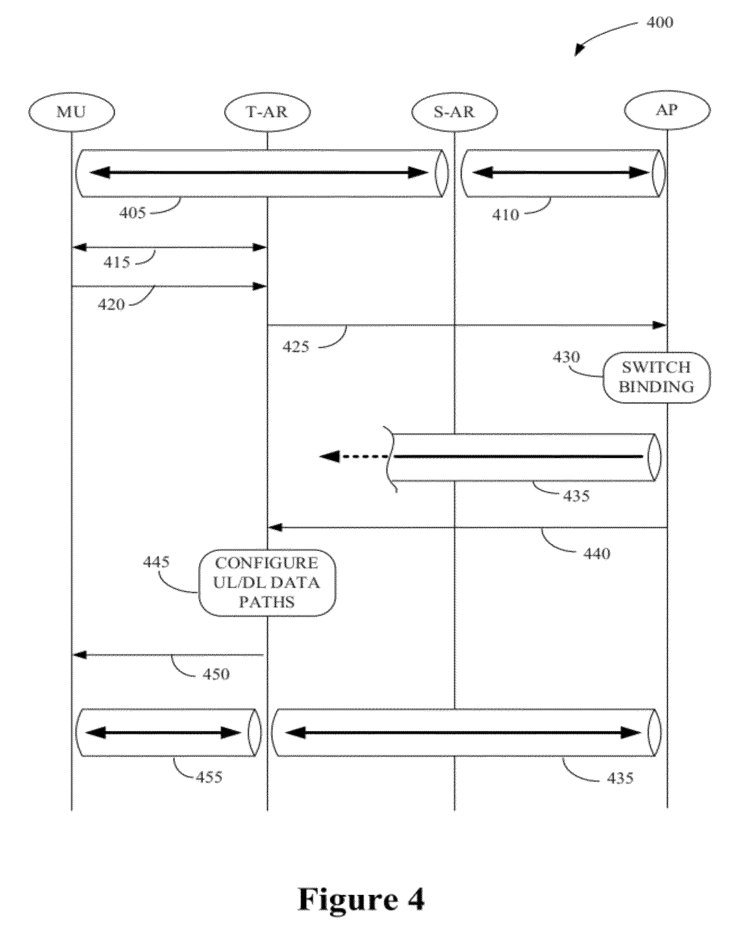

FIG. 4 conceptually illustrates a first exemplary embodiment of a method 400 of performing handoff of a mobile unit between radio access networks that operate according to different radio access technologies. In the illustrated embodiment, a multi-radio mobile device (MU) applies a make-before-break procedure for IP connectivity establishment/registration during the inter-technology handover between a source access router (S-AR) and a target access router (T-AR). A common IP anchor point (AP) manages the connectivity establishment/registration to establish uplink and downlink data paths over the new access technology. Data is sent and received over the old access technology data path concurrently with establishment of the new data path. The common IP anchor point performs a symmetric hand off by switching both the uplink and the downlink data paths for the mobile unit from the old access technology RAN to the new access technology RAN in response to receiving new path registration request.

In the illustrated embodiment, the mobile unit is accessing the network via the source access router in the source access network. The data path includes a first leg 405 between the mobile unit and the source access router and a second leg 410 between the source access router and the common mobility anchor point. The data path is configured to support both uplink and downlink data traffic via the anchor point, as indicated by the double headed arrows. The mobile unit then establishes (at 415) over the air connectivity with the target access router, which can later be used to exchange configuration messages for the make-before-break procedure to establish a data path over the target access network. The mobile unit can then transmit (at 420) an IP data path registration request that serves as a handover trigger. Persons of ordinary skill in the art having benefit of the present disclosure should appreciate that the nature and format of the registration request may be access technology standard specific. For example, if CMIPv4 is used, the registration request may be a MIPv4 Registration request; if CMIPv6 is used, the registration request may be MIPv6 Binding Update; if PMIP or GTP is used, the registration request may be dynamic host configuration protocol (DHCP) message requesting IP connectivity establishment. The target access router may then forward (at 425) the registration request to the common anchor point. Persons of ordinary skill in the art having benefit of the present disclosure should appreciate that the nature and format of the request transmitted between the target access router and the common anchor point may be access technology standard specific. For example, if CMIP or PMIP is used, the registration message that is transmitted (at 425) may be a MIPv4 Registration request or MIPv6 Binding Update, whereas if GTP is used, the registration message would be a GTP specific message.

In response to receiving (at 425) the registration request, the anchor point may switch (at 430) the binding of the uplink and downlink data path to the mobile unit from the source access router to the target access router. The anchor point may also initiate procedures to tear down the uplink and downlink data path tunnels to the source access router in response to receiving the registration message. In the illustrated embodiment, the common anchor point concurrently performs two actions in response to switching (at 430) the binding of the mobile unit: (1) the anchor point begins to transmit the available downlink data packets towards the target access router over a downlink 435 and (2) the anchor point transmits (at 440) a response confirming the registration request to the target access router. Although the right-hand side of the tunnel (435) is programmed at the anchor point once the binding has been switched (at 430), the target access router does not program the leg of the downlink towards the mobile unit until it has received and processed the registration reply. Consequently, downlink traffic to the mobile unit may be dropped until the target access router is able to configure the downlink data path.

The target access router performs (at 445) a symmetric configuration of the uplink and downlink data paths in response to receiving the reply (at 440). The target access router also transmits (at 450) configuration information to the mobile unit that can be used to configure both the uplink and the downlink data paths. The mobile unit can use this information to configure the data paths and establish the link 455 between the mobile unit and the target access router. At this point, uplink and downlink traffic can be communicated between the mobile unit and the network peers via the anchor point, as indicated by the double headed arrows. As discussed herein, the first exemplary embodiment of the method 400 results in a time gap during which downlink data packets may be lost. The time gap is a function of the transmission time between the common anchor point and the target access router and the processing time of the registration response and the associated data path configuration at the target radio access network. In some embodiments, the time gap may be in the range 20-100 msec. Downlink data transmitted during the time gap is lost and may not be recoverable, particularly for time-sensitive, data-intensive applications that do not implement retransmission techniques such as automatic repeat request (ARQ, HARQ). One exemplary time-sensitive, data-intensive application that is widely used is video streaming over UDP. Video servers for the video streams do not implement retransmission for lost data. High resolution video streams can be transmitted at data rates up to 10 Mb/sec. Consequently, losing 20-100 msec of downlink data may result in a total data loss of 1 Mb. This lost data prevents seamless user experience for video stream application.

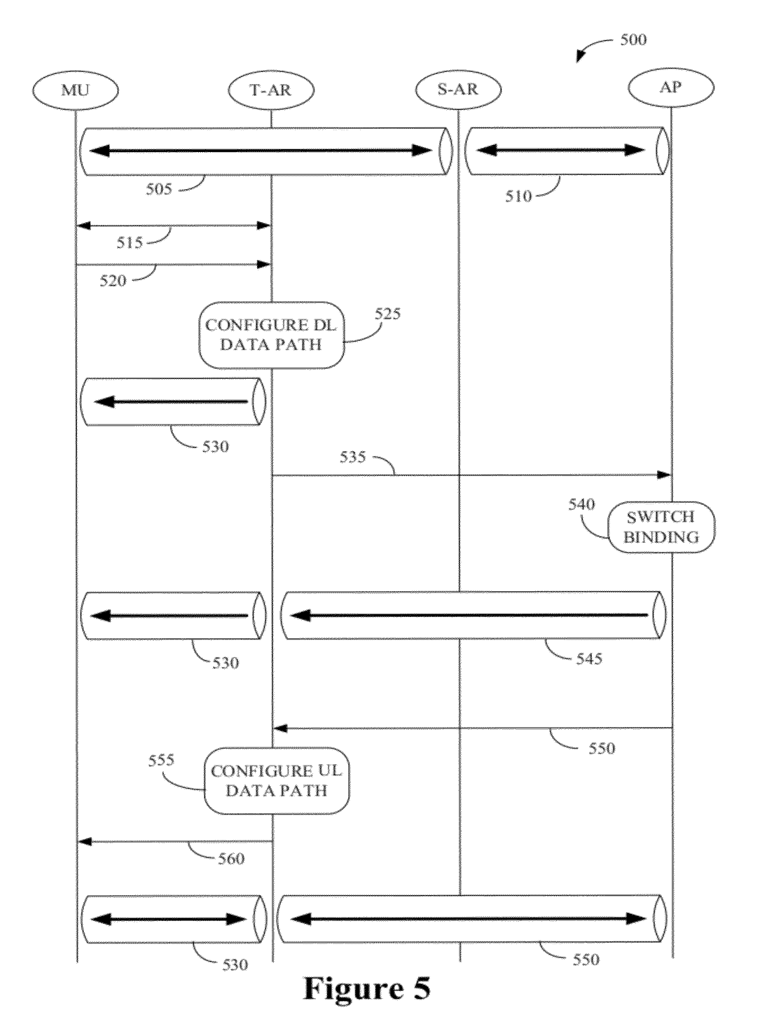

FIG. 5 conceptually illustrates a second exemplary embodiment of a method 500 of performing handoff of a mobile unit (MU) between radio access networks that operate according to different radio access technologies. In the illustrated embodiment, a multi-radio mobile unit (MU) applies a make-before-break procedure for IP connectivity establishment/registration during the inter-technology handover between a source access router (S-AR) and a target access router (T-AR). A common IP anchor point (AP) manages the connectivity establishment/registration to establish uplink and downlink data paths over the new access technology. Data is sent and received over the old access technology data path concurrently with establishment of the new data path. The common IP anchor point performs hand off by switching the downlink and uplink data path tunnels for the mobile unit from the old access technology RAN to the new access technology RAN.

In the illustrated embodiment, the mobile unit is accessing the network via the source access router in the source access network. The data path includes a first leg 505 between the mobile unit and the source access router and a second leg 510 between the source access router and the common mobility anchor point. The data path is configured to support both uplink and downlink data traffic via the anchor point, as indicated by the double headed arrows. The mobile unit then establishes (at 515) over the air connectivity with the target access router, which can later be used to exchange control signaling messages for the make-before-break procedure to establish a data path over the target access network. The mobile unit can then transmit (at 520) an IP data path registration request that serves as a handover trigger. In one embodiment, the IP data path registration request includes the IP address of the mobile unit. For example, the mobile unit may request transfer of the same IP address that it had on the source access technology to the target access technology. In that case, the IP address of the mobile unit is conveyed to the target access network by information in the registration message. Persons of ordinary skill in the art having benefit of the present disclosure should appreciate that the nature and format of the registration request may be access technology standard specific. For example, if MIP is used, the registration request may be a MIPv4 Registration request or MIPv6 Binding Update and if PMIP or GTP is used, the registration request would be dynamic host configuration protocol (DHCP) message requesting registration.

In response to receiving the registration request from the mobile unit, the target access router configures (at 525) a downlink data path 530 from the target access router via target access network (including over the air link) to the mobile unit. For example, the registration request message may include an IP address or other identifier of the mobile unit that can be used to configure the downlink data path. In one embodiment, the target access network may use downlink flow classification information (e.g. for the QoS flows) that is available when IP registration is initiated. This information may be used instead of or in addition to other configuration information. For example, if QoS flows were established prior to the target access network sending a registration message to the IP anchor point, the QoS information can be used to configure the downlink data path. This configuration may be referred to as an asymmetric data path configuration because the downlink data path is configured independently of the uplink data path and configuration of the uplink and downlink data paths does not occur concurrently or in response to the same signals or messages. The target access router may also forward (at 535) the registration request to the common anchor point. Persons of ordinary skill in the art having benefit of the present disclosure should appreciate that the nature and format of the request transmitted between the target access router and the common anchor point may be access technology standard specific. For example, if CMIP or PMIP is used, the registration message that is transmitted (at 535) may be a MIPv4 Registration request or MIPv6 Binding Update, whereas if GTP is used, the registration message would be a GTP specific message.

In response to receiving (at 535) the registration request, the anchor point may switch (at 540) the binding of the uplink and downlink data path to the mobile unit from the source access router to the target access router. The anchor point may also initiate procedures to tear down the uplink and downlink data path tunnels to the source access router in response to receiving the registration request. In the second exemplary embodiment, the common anchor point concurrently performs two actions in response to switching (at 540) the binding of the mobile unit: (1) the anchor point begins to transmit the available data packets towards the target access router over a downlink 545 and (2) the anchor point transmits (at 550) a response confirming the registration request to the target access router. In contrast to the first exemplary embodiment depicted in FIG. 4, both legs 530, 545 of the downlink path may be programmed by the time downlink packets are ready to be transmitted in response to the binding having been switched (at 540). Consequently, downlink traffic transmitted from the anchor point (as indicated by the boldfaced arrows) may be successfully received by the mobile unit concurrently (or even before) with the target access router receiving and processing the response 550 and before the target access router configures the uplink data path from the mobile unit to the target access router. In one embodiment, a timer may be started when the data path link 530 is configured and the data path link 530 may be torn down if no response is received from the anchor point before expiration of the timer or if the registration fails. The timer may therefore be used to conserve air interface resources by tearing down the tunnel 530 when the handover is delayed, interrupted, or fails. In one embodiment, a data path may subsequently be established according to the conventional “symmetric” techniques in cases when the timer expires and the data path link 530 is torn down. In one embodiment, the data path may be subsequently established according to the conventional symmetric techniques when a response message indicating acceptance of the request is delayed until after expiration of the timer and consequently received after the datapath link 530 has been torn down.

The target access router performs (at 555) the asymmetric configuration of the uplink data path in response to receiving the reply (at 550). The target access router also transmits (at 560) the registration reply containing configuration information to the mobile unit that can be used to configure the uplink data path. The mobile unit can use this information to configure the uplink data path so that the mobile unit can transmit packets on the uplink. At this point, uplink and downlink traffic can be communicated between the mobile unit and the network peers (tunneled via target access network to the anchor point), as indicated by the double headed arrows. Implementing the asymmetric configuration of the uplink and downlink data paths at different points in the handoff procedure can reduce or eliminate the time gap during which downlink data packets may be lost at least in part because the tunnel 530 from the target access router to the mobile unit has been “optimistically” preconfigured so that it is available to carry downlink data packets as soon as the anchor points switches (at 540) the binding. Embodiments of the method 500 may therefore be used to support seamless user experience for time-sensitive, data-intensive application such as high data rate video streaming applications.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method for implementation in a target access network, comprising:
configuring a downlink data path from the target access network to a mobile device concurrently with transmitting a data path registration request from the target access network to an anchor point during handoff of the mobile device from a source access network to the target access network.

2. The method of claim 1, wherein configuring the downlink data path comprises configuring the downlink data path using an Internet Protocol (IP) address of the mobile device.

3. The method of claim 1, wherein configuring the downlink data path comprises configuring the downlink data path using downlink flow classification information available at the target access network.

4. The method of claim 1, comprising starting a timer at the target access network in response to configuring the downlink data path and tearing down the established downlink data path if the timer expires before the anchor point responds to the data path registration request or in response to the data path registration request being rejected.

5. The method of claim 4, comprising performing symmetric configuration of the uplink and downlink data paths after the established downlink data path is torn down in response to expiration of the timer expiration, said symmetric configuration being performed in response to receiving a delayed acceptance of the registration request.

6. The method of claim 1, comprising forwarding at least one downlink packet to the mobile device prior to or concurrently with receiving a data path registration response from the anchor point indicating that the anchor point has switched a data path binding from the source access network to the target access network.

7. The method of claim 1, comprising completing the data path setup by configuring an uplink direction data path from the mobile device via the target access network to the anchor point in response to receiving the data path registration response.

8. The method of claim 1, comprising forwarding said at least one downlink packet from the target access network to the mobile device over the downlink data path prior to or concurrently with configuring the uplink data path.

9. A method for implementation in a mobile device, comprising:
processing at least one downlink data packet received from a target access network before receiving a data path registration response indicating that an anchor point has switched a data path binding from a source access network to the target access network in response to a request to handoff the mobile device from the source access network to the target access network.

10. The method of claim 9, wherein processing said at least one downlink packet comprises processing said at least one downlink packet at the mobile device prior to or concurrently with the target access network receiving a data path registration response indicating that the anchor point has switched a data path binding from the source access network to the target access network.

11. The method of claim 10, wherein receiving said at least one downlink packet comprises receiving said at least one downlink packet concurrently with the target access network configuring an uplink data path from the mobile device to the target access network in response to receiving the data path registration response.

12. The method of claim 9, comprising establishing an uplink data path between the mobile device and the target access network in response to the mobile device receiving the data path registration response indicating that the anchor point has switched the data path binding from the source access network to the target access network.

13. The method of claim 12, comprising transmitting at least one uplink packet from the mobile device over the uplink data path between the mobile device and the target access network.
